(19) United States
(12) Patent Application Publication
(10) Pub. No.: US 2006/0197962 A1
(43) Pub. Date: Sep. 7, 2006

(54) DUAL-RESOLUTION PRINTING METHOD

(76) Inventors: Chen-Chung Chen, Tao-Yuan Hsien (TW); Cheng-Huei Chiang, Tai-Chung Hsien (TW)

Correspondence Address: NORTH AMERICA INTELLECTUAL PROPERTY CORPORATION, P.O. BOX 506, MERRIFIELD, VA, 22116, US

(21) Appl. No.: 10/906,780

(22) Filed: Mar. 7, 2005

(51) Int. Cl. G06K 15/02

(52) U.S. Cl. 358/1.2; 358/1.9

(57) ABSTRACT

A dual-resolution printing method for printing a document in accordance with a combination resolution arising from a first resolution and a second resolution is described. The printing method extracts an image feature of the document, which is distinguished into a smooth feature, a homogenous level feature and a edge feature according to the differences in color levels between pixels. The portions of the document with the smooth feature and the homogeneous level feature are printed using low-resolution quality, and the portions of the document with the edge feature are printed using high-resolution quality. The dual-resolution printing method is introduced to speed up the printing procedure, and meet a high printing quality in the same time.

### BACKGROUND OF INVENTION

1. Field of the Invention

The present invention relates to a dual-resolution printing method, and more particularly to a printing method is applicable to multi-function office machines and printers performed in the halftone mode and having both high and low resolutions printing process.

2. Description of the Prior Art

As printers, scanners or other multi-function office machines have become more and more popular, demands on both printing quality and speed for these machines have increased on a daily basis. Current four-color, six-color or seven-color printers provide users with selections of fast-printing, general-printing and best-printing. By doing so, these printers provide trade-offs between the printing quality in terms of resolution and the printing speed.

As for color printing, the image processing flow applying to fast-printing, general-printing and best-printing is shown in FIG. 1. The flow includes steps of inputting the original document (S101), scanning and sampling the original document through the scanning module (S103), generating the digitalized RGB image data inputs (S105), undergoing CMYK transformation, half-color toning processing and graphic and text enhancement processing (S107), generating the half-color toning image on the CMYK basis (S109), and then printing the “end product” with the printing module (S111). The CMYK transformation, half-color processing and appropriate arrangement for locations of color printing are necessary from the scanning and sampling in order to provide human eyes with changes in colors and color levels.

The primary difference between the fast-printing, general-printing and best-printing is the difference of the resolution and the number of the color levels used. The resolution used in fast-printing is 150 dpi and the color level for the fast-printing is two, leading to a higher printing rate (speed) with an inferior printing quality. On the other hand, the best-printing probably has a resolution of 600 dpi and a color level of six (6), meaning that a superior printing quality with a lower printing rate (speed) is obtained.

In general, current available printing modes all have to compromise between the printing speed and the printing quality.

### SUMMARY OF INVENTION

A dual-resolution printing method is introduced to print a portion of the document where differences in color levels between pixels are light level area with a low resolution and another portion of the document having the edge area with a high resolution, so as to have high printing quality and printing rate at the same time.

In accordance with the claimed invention, the present dual-resolution printing method for printing a document in accordance with a combination resolution arising from a first resolution and a second resolution includes the following steps. An image feature of the document is extracted. The image feature is defined by differences in color levels between pixels. The document is virtually separated into a first image portion and a second image portion with respect to the image feature. The first image portion of the document is printed on the basis of the first resolution, and the second image portion of the document is printed on the basis of the second resolution.

Further, the dual-resolution printing method is used to print a document in accordance with a combination resolution arising from a first resolution and a second resolution. The document undergoes color transformation with respect to the first resolution to a first color plate, an image feature of the first color plate is obtained. The image feature is defined by differences in color levels between pixels. The resolution of the first plate is enhanced to the second resolution in order to obtain a second color plate. A halftone treatment is performed on the second color plate. The pixels on a portion of the second color plate are merged according to the image feature and then the pixel-merged portion of the second color plate is printed with the first resolution, and the pixel-unmerged portion of the second color plate is printed with the second resolution.

Particularly, the different portions of the same document with two different resolutions are printed after obtaining the image feature, which is defined by the difference in color level. Accordingly, the corresponding portion of the document in the preferred embodiment of the present invention is able to provide the high printing quality and speed simultaneously, without any compromise or trade-off between them.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a flow chart of the image processing of the color printing according to the prior art;

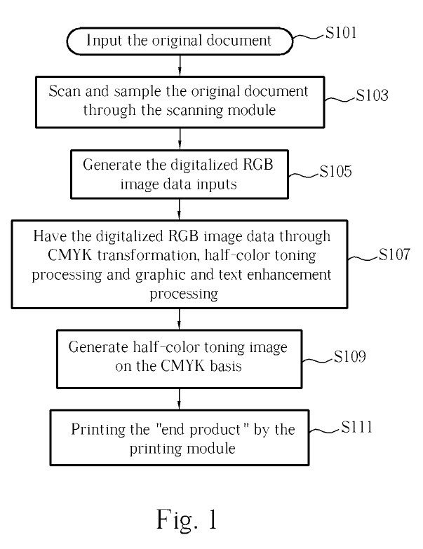

FIG. 2 is a flow chart showing the image processing of the color printing according to the present invention; and

FIG. 3 is a block diagram showing the printed image formats.

### DETAILED DESCRIPTION

The present invention provides a dual-resolution printing method by extracting the image feature of the document to be printed, where the image feature of the document includes a smooth feature, a homogeneous level feature and an edge feature. The preferred embodiment of the present invention then virtually separates the document to be printed into a first image portion and a second image portion by the extracted image feature. The first image portion is preferably defined as the portion of the document having a smooth feature or a homogenous level feature within, and the second image portion is defined as the portion of the document to be printed having an edge feature. Thereafter, a comparatively lower resolution image with the smooth feature or the homogeneous level feature can be identified as printing with low-resolution quality, while a comparatively complicated image need to be identified using high-resolution printing quality.

The method of the preferred embodiment is described that the first image portion is printed with the lower resolution quality, and the second image portion is printed with the higher resolution quality. Therefore, the printing method is implemented to speed up the printing process and meet the high printing quality as well. Namely, the first image portion of the document that is comparatively lower resolution printed with low-resolution quality can shorten the printing hours. On the contrary, the second image portion of the document with comparatively higher resolution is printed with high-resolution quality can enhance the printing quality.

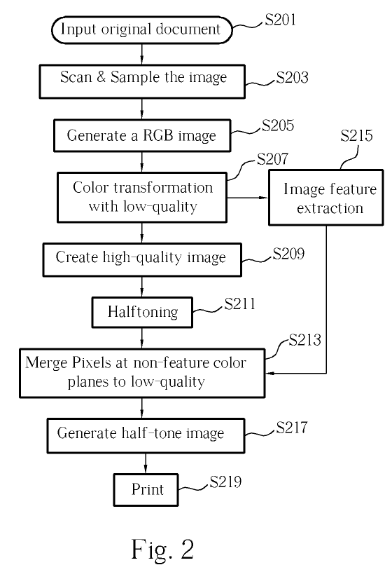

Reference is made to FIG. 2, which is a flow chart of the image processing of the preferred embodiment of the present invention. After inputting the original document to be printed (S201), the present printing method includes steps of scanning and sampling the document through the scanning module (S203) in order to generate a digitalized RGB image (S205). After inputting the RGB image, the present embodiment further transforms the RGB image into the CMYK color with low resolution (e.g. 300 dpi) (S207). After that, a first color plate is obtained, and then the image feature therein is extracted (S215). The aforementioned image feature including a smooth feature, a homogeneous level feature, and an edge feature refers to differences in color levels between pixels of the portion of the document. According to the preferred embodiment of the present invention, the smooth feature or the homogeneous level feature of the image is extracted from the analysis of the first color plate using a statistical method or a theory of probability. And the edge feature of the image is obtained from a high-pass filter.

After the step S207, the printing method according to the preferred embodiment of the present invention enhances the resolution in the first color plate to a higher resolution (e.g. 600 dpi) of a second color plate (S209). In one of the preferred embodiment, the higher resolution image of the second color plate is obtained by enlarging the first color plate. Afterward, the second color plate is performed as halftone treatment (S211). Thereafter, the pixels of the image feature obtained in step S215 are merged (S213). Wherein, the portion with merged-pixel is mainly the portion of the second color plate with the smooth feature or the homogeneous feature, and the else portion of the image without merging the pixels is the portion with edge feature. Since the resolution of the second color plate comes from enhancing the resolution of the first color plate, the image feature of the first color plate still appears on the second color plate. The step of merging pixels is to merge a plurality of pixels to one pixel, for example, to merge two pixels to one pixel can decrease the resolution from 600 dpi to 300 dpi.

After merging pixels on the portion of the document the CMYK (Cyan, Magenta, Yellow, Black) halftone image is generated (S217). Then, the printing method of the preferred embodiment prints the CMYK halftone image through the printing module (S111). In the course of printing, the printing module prints the pixel-merged portion of the document with low resolution (e.g. 300 dpi) and the pixel-uncombined portion thereof on the basis of the higher resolution (600 dpi).

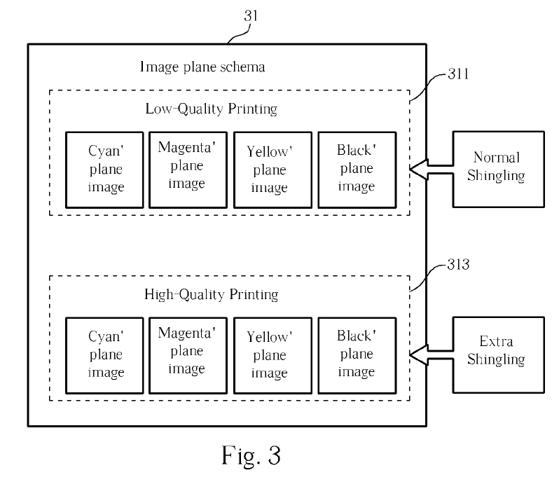

The printing method according to the preferred embodiment of the present invention prints the portion of the document having the smooth feature or the homogeneous level feature with lower resolution and the portion having the edge feature with higher resolution. According to FIG. 3, the outputting color plate 31 having the CMYK halftone image thereon includes a low-quality color plate 311 and a high-quality color plate 313. The printing method of the present embodiment prints the low-quality color plate 311 with lower resolution and the high-quality color plate 313 with higher resolution. For the purpose of obtaining better and better printing quality, the printing of the high-quality color plate 313 is repeated several times.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A dual-resolution printing method for printing a document in accordance with a combination resolution arising from a first resolution and a second resolution, comprising:
extracting an image feature of the document, the document is separated into a first image portion and a second image portion with respect to the image feature;
printing the first image portion of the document on the basis of the first resolution; and
printing the second image portion of the document on the basis of the second resolution.

2. The printing method in claim 1, wherein the image feature is a smooth feature.

3. The printing method in claim 2, wherein the smooth feature is extracted from a statistical method or a theory of probability.

4. The printing method in claim 2, wherein the first image portion refers to a document portion having the smooth feature.

5. The printing method in claim 1, wherein the image feature is a homogenous level feature.

6. The printing method in claim 5, wherein the homogenous level feature is extracted from a statistical method or a theory of probability.

7. The printing method in claim 5, wherein the first image portion refers to a document portion having the homogenous level feature.

8. The printing method in claim 1, wherein the image feature is an edge feature.

9. The printing method in claim 8, wherein the edge feature is extracted from a high-pass filter.

10. The printing method in claim 8, wherein the second image portion refers to a document portion having the edge feature.

11. The printing method in claim 1, wherein the resolution of the second resolution is higher than the first resolution.

12. A dual-resolution printing method for printing a document in accordance with a combination resolution arising from a first resolution and a second resolution, comprising:
color transforming the document with the first resolution into a first color plate;
extracting an image feature of the first color plate;
enhancing the resolution of the first plate to the second resolution in order to obtain a second color plate;
performing a halftone treatment on the second color plate;
merging the pixels in a portion of the second color plate according to the image feature and then printing the pixel-merged portion of the second color plate with the first resolution; and
printing the pixel-unmerged portion of the second color plate with the second resolution.

13. The printing method in claim 12, wherein the step of color transforming is a transforming process from a RGB pattern into a CMYK pattern.

14. The printing method in claim 12, wherein the image feature is a smooth feature.

15. The printing method in claim 14, wherein the smooth feature is extracted from a statistical method or a theory of probability.

16. The printing method in claim 14, wherein the pixel-merged portion of the second color plate is a portion having the smooth feature.

17. The printing method in claim 12, wherein the image feature is a homogenous level feature.

18. The printing method in claim 17, wherein the homogenous level feature is extracted from a statistical method or a theory of probability.

19. The printing method in claim 17, wherein the pixel-merged portion of the second color plate is a portion having the homogenous level feature.

20. The printing method in claim 12, wherein the image feature is an edge feature.

21. The printing method in claim 20, wherein the edge area is extracted from a high-pass filter.

22. The printing method in claim 20, wherein the pixel-unmerged portion of the second color plate is a portion having the edge feature.
